(19) United States
(12) Patent Application Publication
(10) Pub. No.: US 2009/0203380 A1
(43) Pub. Date: Aug. 13, 2009

(54) SYSTEM AND METHOD FOR HANDOVER OF MOBILE STATION IN A WIRELESS MOBILE COMMUNICATION SYSTEM

(75) Inventors: Jeong-Ho PARK, Seoul (KR); Jun-Sung LIM, Suwon-si (KR); Su-Ryong JEONG, Suwon-si (KR); Hyeon-Woo LEE, Suwon-si (KR); Ho-Kyu CHOI, Seongnam-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/370,553

(22) Filed: Feb. 12, 2009

(30) Foreign Application Priority Data
Feb. 12, 2008 (KR) 10-2008-0012776

(51) Int. Cl. H04W 36/00

(52) U.S. Cl. 455/437; 370/332

(57) ABSTRACT

A method for handover by a Mobile Station (MS) in a wireless mobile communication system is provided. The MS receives from a serving Base Station (BS) an identifier and an interference level value of a neighboring BS. The MS determines a hysteresis margin value used for determining handover from the serving BS to the neighboring BS taking into account the interference level value of the neighboring BS. The MS sends a handover request to the serving BS when a difference between strength of a signal received from the neighboring BS and strength of a signal received from the serving BS exceeds the determined hysteresis margin value.

### PRIORITY

This application claims the benefit under 35 U.S.C. §119(a) of a Korean patent application filed in the Korean Intellectual Property Office on Feb. 12, 2008 and assigned Serial No. 10-2008-0012776, the entire disclosure of which is hereby incorporated by reference.

### BACKGROUND OF THE INVENTION

1. Field of the Invention:

The present invention relates generally to a wireless mobile communication system. More particularly, the present invention relates to a system and method for handover of a mobile station in a wireless mobile communication system.

2. Description of the Related Art:

Generally, performance and capacity of wireless mobile communication systems are determined by radio channel characteristics, including inter-cell interference, co-channel interference signals generated in a cell, path loss, multipath fading, etc. Technologies for increasing the performance and capacity of the wireless mobile communication systems include controlling the use of power, channel coding, rake reception and diversity antennas.

In a cellular wireless mobile communication system, a Base Station (BS) receives uplink signals from a plurality of Mobile Stations (MSs). In this case, a signal transmitted by a particular MS may act as an interference component in regard to signals transmitted by other MSs.

When the wireless mobile communication system uses a frequency reuse factor of 1 and an Orthogonal Frequency Division Multiple Access (OFDMA) scheme, uplink interference between MSs in a cell is negligible due to orthogonality between subcarriers. However, inter-cell uplink interference may cause performance degradation of the system. The inter-cell uplink interference may also lead to a reduction in a possible uplink cell signal transmission area or uplink cell coverage.

FIG. 1 is a diagram illustrating a comparison between uplink cell coverages determined by their uplink interference level according to the conventional art.

Referring to FIG. 1, if a first BS 110 receives interference signals from MSs located in the cell boundary of neighboring BSs and the total power of the interference signals is higher than a threshold, the cell coverage of the first BS 110 may be reduced from a cell coverage 100 to a cell coverage 140. As a result, the first BS 110 may not receive an uplink signal from an MS 120, though it can receive an uplink signal from an MS 130.

On the other hand, in the case of a second BS 160 neighboring the first BS 110, as the power of interference signals received from MSs located in the cell boundary of neighboring BSs is lower than or equal to a threshold, it has a normal uplink cell coverage 150. Thus, the second BS 160 can receive an uplink signal from an MS 170.

With reference to the relevant equations, a detailed description will now be made of the reason why the first BS 110 and the second BS 160 are different in the uplink cell coverage.

Herein, a required Signal to Interference and Noise Ratio (SINR) satisfying a Modulation and Coding Scheme (MCS) level that an MS, belonging to a particular BS, is assigned will be denoted by r_{req}(MCS). Further, required transmission power for all subcarriers that an MS is allocated will be represented by ‘P’. P can be defined as Equation (1).

P=NIₖ+Lₖ+r_{req}(MCS) (1)

In Equation (1), NIₖ denotes an average uplink interference and noise level per subcarrier of uplink signals that a BS #k has received, and Lₖ denotes a path gain determined by a distance between an MS and the BS #k. When an uplink interference level of the BS #k increases by Δ, Equation (1) can be written as Equation (2).

P=(NIₖ+Δ)+(Lₖ−Δ)+r_{req}(MCS) (2)

When transmission power allocated to an MS is fixed and its interference level increases by Δ, a BS can exchange signals with an MS located at a distance of up to (Lₖ−Δ) at the same MCS level. The BS cannot receive uplink signals from an MS located at a distance further than (Lₖ−Δ).

As described with reference to Equation (1) and Equation (2), when an uplink interference level NI in a BS #k, to which an MS allocated the maximum power P and the minimum MCS level belongs, increases by Δ, it may not be possible for the MS to continue to receive service.

For example, in FIG. 1, the second BS 160 can exchange signals with the MS 170 which is spaced therefrom by a distance r, whereas the first BS 110 cannot receive uplink signals from the MS 120 which is separated therefrom by the same distance r.

The reduction in the uplink cell coverage may cause asymmetry (or unbalance) between the uplink cell coverage and downlink cell coverage. For example, in a case of Voice over Internet Protocol (VoIP) service, it may be difficult to offer services in a cell where the uplink cell coverage and downlink cell coverage are asymmetric.

Therefore, a need exists for an improved system and method capable of reducing uplink inter-cell interference in a wireless mobile communication system.

### SUMMARY OF THE INVENTION

An aspect of the present invention is to address at least the above-mentioned problems and/or disadvantages and to provide at least the advantages described below. Accordingly, an aspect of the present invention is to provide a system and method capable of reducing uplink inter-cell interference in a wireless mobile communication system.

Another aspect of the present invention is to provide a system and method capable of extending uplink cell coverage that has been reduced due to uplink inter-cell interference signals in a wireless mobile communication system.

Further another aspect of the present invention is to provide a system and method for performing handover of an MS taking an uplink interference level into account in a wireless mobile communication system.

According to an aspect of the present invention, a method for handover by a Mobile Station (MS) in a wireless mobile communication system is provided. The method includes receiving from a serving Base Station (BS) an identifier and an interference level value of a neighboring BS, determining a hysteresis margin value used for determining handover from the serving BS to the neighboring BS taking into account the interference level value of the neighboring BS and sending a handover request to the serving BS when a difference between the strength of a signal received from the neighboring BS and the strength of a signal received from the serving BS exceeds the determined hysteresis margin value.

According to another aspect of the present invention, a method for supporting handover of a Mobile Station (MS) by a serving Base Station (BS) in a wireless mobile communication system is provided. The method includes determining an interference level value of the serving BS, receiving an identifier and an interference level value of a neighboring BS from the neighboring BS, transmitting the identifier and the interference level value of the neighboring BS to the MS when the interference level value of the serving BS is lower than a first threshold and receiving a handover request message from the MS that has determined handover taking into account the interference level values of the serving BS and the neighboring BS.

According to further another aspect of the present invention, a method for supporting handover of a Mobile Station (MS) by a neighboring Base Station (BS) in a wireless mobile communication system is provided. The method includes determining an interference level value of the neighboring BS and transmitting an identifier and the interference level value of the neighboring BS to the serving BS, when the determined interference level value of the neighboring BS exceeds a first threshold.

According to yet another aspect of the present invention, a wireless mobile communication system including a Mobile Station (MS), a serving Base Station (BS) that provides a service to the MS, and at least one neighboring BS is provided. As part of the system, the MS receives an identifier and an interference level value of the neighboring BS from the serving BS, determines a hysteresis margin value, used for determining handover from the serving BS to the neighboring BS, using the interference level value of the neighboring BS, determines the signal strength received from the neighboring BS, determines the signal strength received from the serving BS, and sends a handover request message to the serving BS when a difference between the two signal strengths exceeds the determined hysteresis margin value. The neighboring BS determines an interference level value of the neighboring BS, and transmits the identifier and the interference level value of the neighboring BS to the serving BS, when the determined interference level value of the neighboring BS exceeds a first threshold.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description when taken in conjunction with the accompanying drawings in which:

FIG. 1 is a diagram illustrating a difference between uplink cell coverages determined by their uplink interference level according to the conventional art;

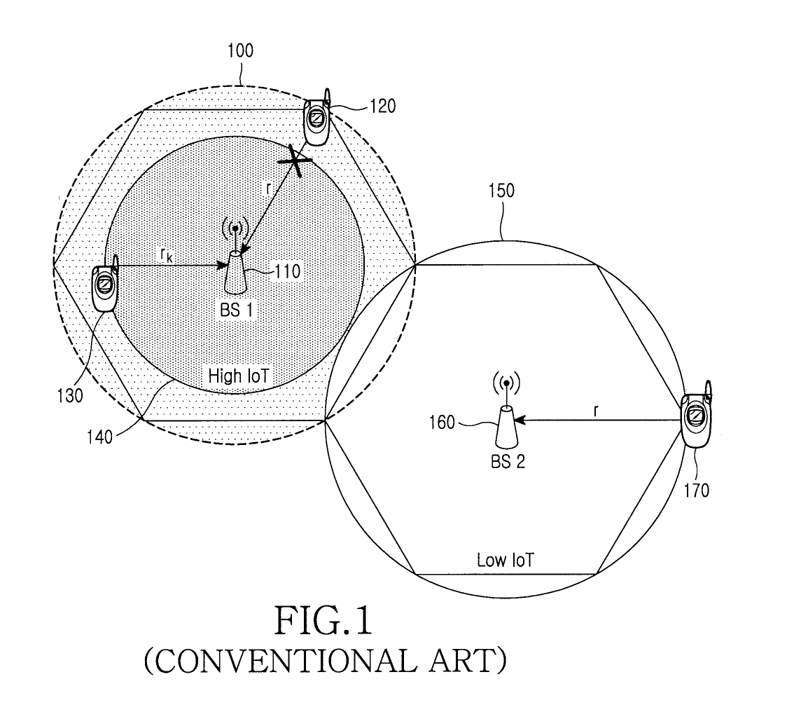

FIG. 2 is a diagram illustrating a method for performing handover of an MS taking an interference level into consideration according to an exemplary embodiment of the present invention;

FIG. 3 is a signaling diagram illustrating a process up to the handover request by an MS according to an exemplary embodiment of the present invention; and

FIG. 4 is a diagram illustrating comparison between uplink cell coverages determined before and after an exemplary embodiment of the present invention is applied.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a system and method capable of resolving an asymmetry problem between uplink cell coverage and downlink cell coverage by handing over a Mobile Station (MS) to a neighboring cell in a wireless mobile communication system.

Conventionally, the controlling of power or the scheduling of allocated resources was suggested to address the asymmetry problem between uplink cell coverage and downlink cell coverage. However, the availability of these schemes is temporary unless distribution of MSs is readjusted.

The distribution of MSs within a cell is generally assumed to be uniform. However, in reality this is not normally the case. Rather, density distribution of MSs shows a large variation according to area, so that each cell may have a different uplink interference level. Accordingly, cell coverage of the uplink may vary from cell to cell. In other words, when each cell uses the same power control scheme, downlink coverages of the cells are identical to each other, but their uplink coverages may be different from each other because of their different inter-cell interference levels. To address this problem, power controlling or resource scheduling was used conventionally, in which interference levels of neighboring cells are taken into consideration. However, these conventional methods were executed on the assumption that distribution of MSs is uniform. When the distribution of MSs is assumed to be uniform, the methods can maintain similar uplink cell coverage for each cell at the sacrifice of cell throughput.

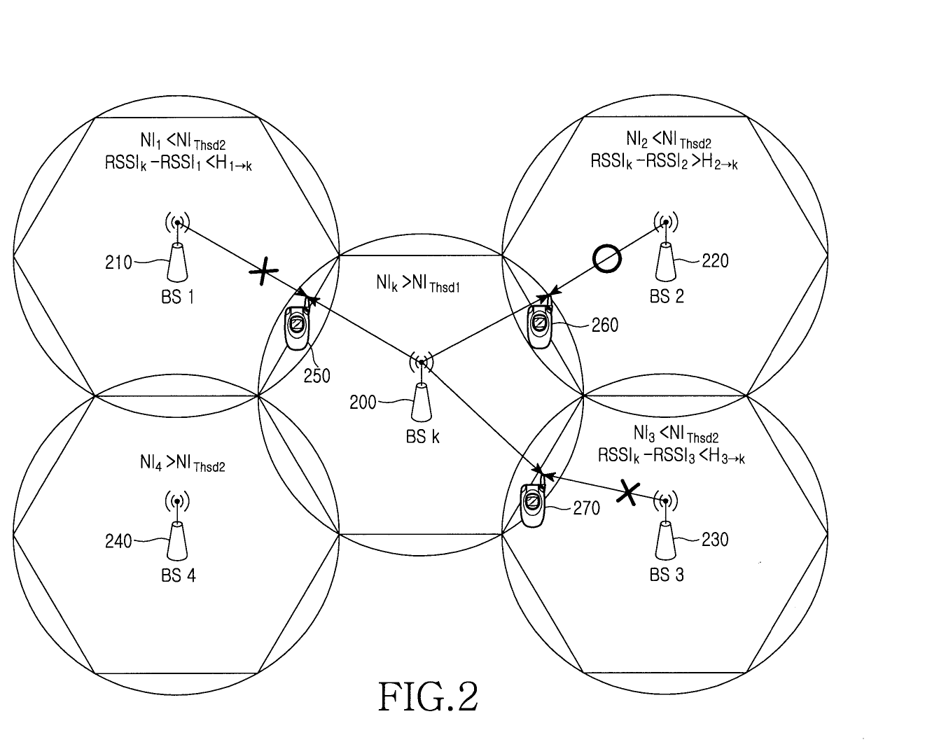

FIG. 2 is a diagram illustrating a method for performing handover of an MS taking an interference level into consideration according to an exemplary embodiment of the present invention.

Referring to FIG. 2, a Base Station (BS) #k 200 measures a current uplink interference level and an average interference level for a time period previous to the current time. The uplink interference level denotes an average uplink interference and noise level per subcarrier of uplink signals that a particular BS has received. The uplink interference level can also be expressed as Interference over Thermal noise (IoT), which is an interference-to-thermal noise ratio. The IoT can be defined as (I+N)/N, where I denotes interference and N denotes noise. Herein, the interference level will be denoted by ‘NI’, where NIx denotes an NI value of a BS #x.

When its averaged NI value exceeds a first threshold NI_{Thsd1}, the BS #k 200 transmits its Identifier (ID) and NIₖ to neighboring BSs 210, 220, 230 and 240. In contrast, when its averaged NI value does not exceed the first threshold NI_{Thsd1}, the BS #k 200 does not transmit its ID and NIₖ.

The neighboring BSs 210 to 240 each store the ID and NIₖ of the BS #k 200, and, when their NI value is lower than a second threshold NI_{Thsd2}, they broadcast the ID and NIₖ of the BS #k 200 to MSs managed by each of them through a broadcasting channel. For example, in FIG. 2, the BS #1 210, the BS #2 220 and the BS #3 230 broadcast the ID and NIₖ of the BS #k 200 to MSs 250, 260 and 270 in their cells. However, the BS #4 240 does not broadcast the ID and NIₖ of the BS #k 200 since its NI value NI₄ is not lower than the second threshold NI_{Thsd2}.

The MSs 250, 260 and 270 determine their unique hysteresis margin values H_{1→k}, H_{2→k} and H_{3→k}, respectively. Here, H_{1→k} denotes a hysteresis margin value needed to determine if handover from a BS #1 to a BS #k should be performed. In an exemplary implementation, the NIₖ is used to determine unique hysteresis margin values of the MSs 250, 260 and 270. Equation (3) below is given to determine, for example, the hysteresis margin value H_{1→k} of the MS 250.

H_{1→k}=f(σ₁²,σₖ²μ, NIₖ) (3)

In Equation (3), f( )denotes a specific function, σ₁² denotes a variance of the strength of a signal received from a BS #1, σₖ² denotes a variance of the strength of a signal received from a BS #k, and μ denotes a frequency of unnecessary handovers, broadcast from the BS #1. When the hysteresis margin value is set lower than a fading fluctuation between a BS and an MS, the MS may re-send a handover request to the existing BS after completing handover to a target BS. In order to prevent the repetition of unnecessary handovers between two BSs, i.e. occurrence of a ping-pong phenomenon, there is a need to set a hysteresis margin value greater than the fading fluctuation.

Given that the NI value of the BS #k is high, the H_{1→k} can be set as a hysteresis margin value relative to another BS #z whose interference level is not as high. That is, the hysteresis margin value H_{1→k} can be set as a value lower than H_{1→k}, for example H_{1→z}. Alternatively, the hysteresis margin value H_{1→k} can be preset. This is to allow handover to the BS #k to be more easily performed.

The MSs 250, 260 and 270 receive signals from their current serving BSs and a signal from the BS #k 200, respectively, and estimate Received Signal Strength Indications (RSSIs). An MS sends a handover request to its serving BS when a difference between RSSI from the BS #k 200 and RSSI from each serving BS exceeds a hysteresis margin value unique to each MS. For example, in FIG. 2, the MS 260 sends a handover request to the BS #2 220 when a difference between RSSI from the BS #k 200 and RSSI from the BS #2 220 exceeds H_{2→k} (i.e. RSSIₖ-RSSI₂>H_{2→k}). A message used for the handover request may include information on a handover target BS. When the MS 260 is handed over to the BS #k 200, the power of an interference signal of the MS 260, which was being applied to the BS #k 200, is reduced or removed.

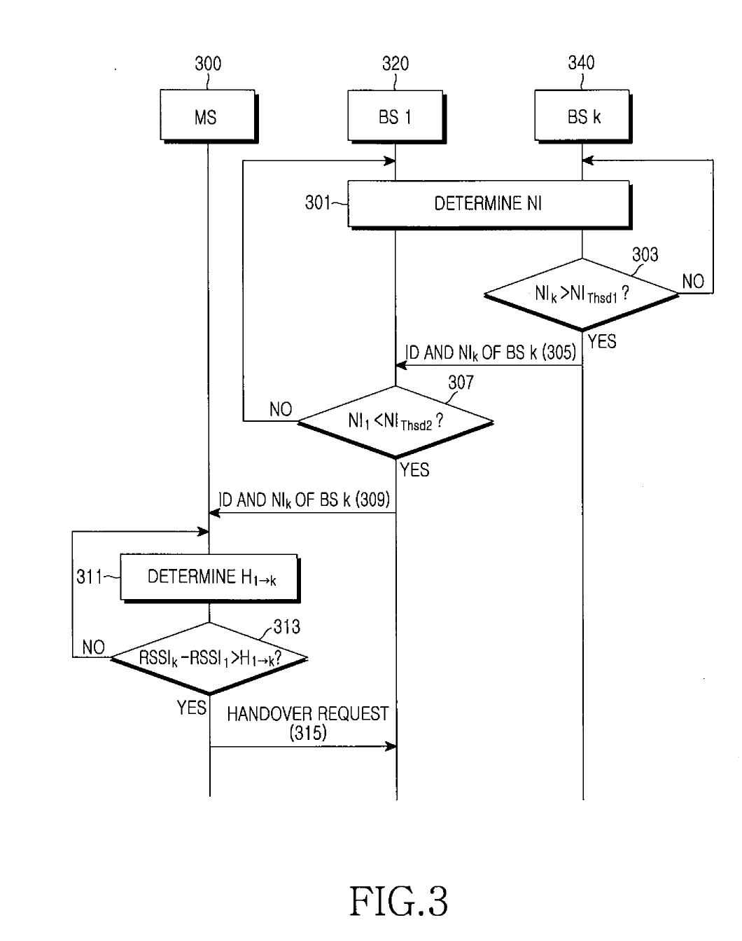

FIG. 3 is a signaling diagram illustrating a process by an MS according to an exemplary embodiment of the present invention.

Referring to FIG. 3, an MS 300 is located in a cell managed by a BS #1 320. A BS #k 340 is a BS neighboring the BS #1 320.

The BS #1 320 and BS #k 340 respectively determine an NI₁ value and an NIₖ value in step 301. The BS #k 340 determines whether the NIₖ value exceeds a first threshold NI_{Thsd1} in step 303. When the NIₖ value exceeds NI_{Thsd1}, the BS #k 340 transmits an ID and the NIₖ value of the BS #k 340 to the BS #1 320 in step 305. However, when the NIₖ value does not exceed NI_{Thsd1}, the BS #k 340 returns to step 301.

When it is determined that the NI₁ value is lower than a second threshold NI_{Thsd2} in step 307, the BS #1 320 transmits the ID and the NIₖ value of the BS #k 340 to the MS 300 in step 309. On the other hand, when the NI₁ value is not lower than NI_{Thsd2}, the BS #1 320 returns to step 301.

The MS 300 determines a hysteresis margin value H_{1→k} in step 311, and determines in step 313 whether a difference between RSSIₖ from the BS #k 340 and RSSI₁ from the BS #1 320 exceeds H_{1→k}. If it is determined that the difference between RSSIₖ from the BS #k 340 and RSSI₁ from the BS #1 320 exceeds H_{→k}, the MS 300 sends to the BS #1 320 a request for handover to the BS #k 340 in step 315. However, if the difference between RSSIₖ from the BS #k 340 and RSSI₁ from the BS #1 320 does not exceed H_{1→k}, the MS 300 repeats step 311 and its succeeding steps.

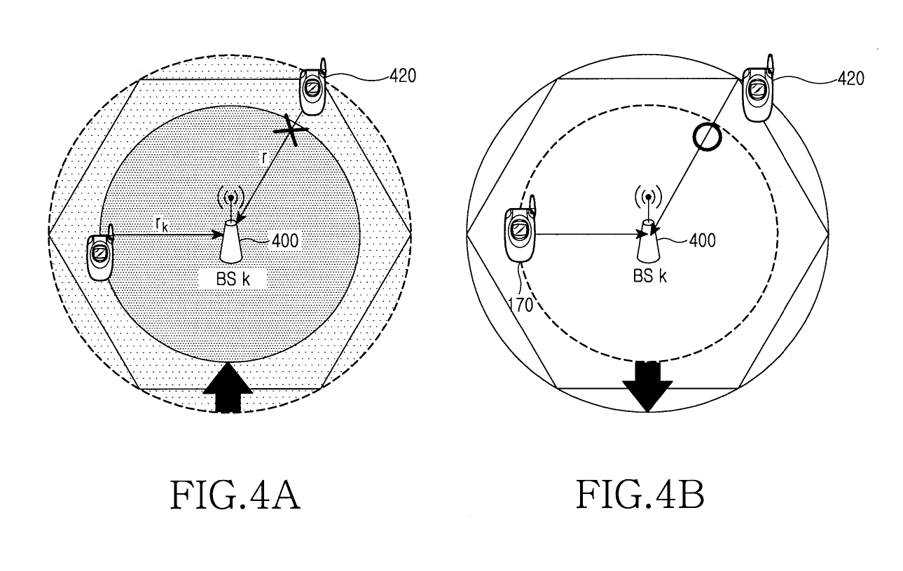

FIG. 4 is a first and second diagram illustrating a comparison between uplink cell coverages determined before and after an exemplary embodiment of the present invention is applied.

Referring to FIG. 4, a BS #k 400, illustrated in diagram (A) and before an exemplary embodiment of the present invention is applied thereto, cannot receive uplink signals from an MS 420 due to uplink signal interference from MSs located in neighboring cells.

However, after an exemplary embodiment of the present invention is applied thereto, the BS #k 400 illustrated in diagram (B) can normally receive uplink signals from the MS 420 since at least one MS 170, which causes uplink signal interference as it is located in a neighboring cell's overlapping coverage area, is handed over to the BS #k 400.

Although an operation according to an exemplary embodiment of the present invention has been described on the assumption that one MS exists in one cell, the present invention can also be applied even to the case where two or more MSs exist in one cell.

As is apparent from the foregoing description, exemplary embodiments of the present invention hand over an MS to a neighbor cell in a wireless mobile communication system, the MS transmitting an uplink interference signal, power of which is greater than a threshold, to the neighboring cell, thereby extending uplink coverage of the neighboring cell.

While the invention has been shown and described with reference to exemplary embodiments thereof, it will be understood by those skilled in the art that various changes in form and details may be made therein without departing from the spirit and scope of the invention as defined by the appended claims and their equivalents.

What is claimed is:

1. A method for handover by a Mobile Station (MS), the method comprising:
receiving an identifier and an interference level value of a neighboring BS;
determining a hysteresis margin value based on the interference level value;
determining if handover from the serving BS to the neighboring BS should be performed using a difference between the strength of a signal received from the neighboring BS and the strength of a signal received from the serving BS; and
sending a handover request to the serving BS if it is determined that handover should be performed.

2. The method of claim 1, wherein the determining if the handover should be performed comprises determining that the handover should be performed when the difference between the strength of the signal received from the neighboring BS and the strength of the signal received from the serving BS exceeds the determined hysteresis margin value.

3. The method of claim 1, wherein the interference level value comprises an average uplink interference and noise level per subcarrier of an uplink signal received by the neighboring BS.

4. The method of claim 1, wherein the interference level value is defined as (I+N)/N, where I denotes interference and N denotes noise.

5. The method of claim 1, wherein the determining of the hysteresis margin value comprises using the equation:
H_{ServingBS→Neighborin gBS}=f(σ_{ServingBS}², σ_{Neighborin gBS}²μ, NI_{Neighborin gBS})
where f( ) denotes a specific function, H_{ServingBS→NeighboringBS} denotes a hysteresis margin value used for determining handover from the serving BS to the neighboring BS, σ_{ServingBS}² and σ_{NeighboringBS}² respectively denote variances of the strengths of the signals received from the serving BS and the neighboring BS, μ denotes a frequency of unnecessary handovers, broadcast from the serving BS, and NI_{NeighboringBS} denotes an interference level value of the neighboring BS.

6. The method of claim 1, wherein the sending of the handover request comprises sending a message denoting a handover request to the serving BS, wherein the message comprises an identifier of the neighboring BS.

7. A method for supporting handover of a Mobile Station (MS) by a serving Base Station (BS), the method comprising:
determining an interference level value of the serving BS;
receiving an identifier and an interference level value of a neighboring BS;
transmitting the identifier and the interference level value of the neighboring BS to the MS if the interference level value of the serving BS is lower than a first threshold; and
receiving a request message from the MS for handover from the serving BS to the neighboring BS.

8. The method of claim 7, wherein each of the interference level values of the serving BS and the neighboring BS comprises an average uplink interference and noise level per subcarrier of a first and second uplink signal received by the serving BS and the neighboring BS respectively.

9. The method of claim 7, wherein each of the interference level values of the serving BS and the neighboring BS is defined as (I+N)/N, where I denotes interference and N denotes noise.

10. The method of claim 7, wherein the receiving of the request message comprises receiving the identifier of the neighboring BS.

11. A method for supporting handover of a Mobile Station (MS) by a neighboring Base Station (BS), the method comprising:
determining an interference level value of the neighboring BS; and
transmitting an identifier and the interference level value of the neighboring BS to a serving BS, when the determined interference level value exceeds a first threshold.

12. The method of claim 11, wherein the interference level value comprises an average uplink interference and noise level per subcarrier of an uplink signal that the neighboring BS has received.

13. The method of claim 11, wherein the interference level value of the neighboring BS is defined as (I+N)/N, where I denotes interference and N denotes noise.

14. A wireless mobile communication system comprising:
a Mobile Station (MS);
a serving Base Station (BS) that provides a service to the MS; and
at least one neighboring BS,
wherein the MS receives an identifier and an interference level value of the neighboring BS, determines a hysteresis margin value based on the interference level value, determines the strength of a signal received from the neighboring BS, determines the strength of a signal received from the serving BS, determines if handover from the serving BS to the neighboring BS should be performed using a difference between the strength of the signal received from the neighboring BS and the strength of the signal received from the serving BS and sends a handover request message to the serving BS if it is determined that handover should be performed, and further wherein the neighboring BS determines the interference level value of the neighboring BS, and transmits the identifier and the interference level value of the neighboring BS to the serving BS when the determined interference level value of the neighboring BS exceeds a first threshold.

15. The wireless mobile communication system of claim 14, wherein the serving BS determines an interference level value of the serving BS, receives the identifier and the interference level value of the neighboring BS from the neighboring BS, transmits the identifier and the interference level value of the neighboring BS to the MS when the interference level value of the serving BS is lower than a second threshold, and receives the handover request message from the MS.

16. The wireless mobile communication system of claim 15, wherein each of the interference level values of the serving BS and the neighboring BS comprises an average uplink interference and noise level per subcarrier of a first and second uplink signal received by the serving BS and the neighboring BS respectively.

17. The wireless mobile communication system of claim 15, wherein each of the interference level values of the serving BS and the neighboring BS is defined as (I+N)/N, where I denotes interference and N denotes noise.

18. The wireless mobile communication system of claim 14, wherein the hysteresis margin value is determined using the equation:
H_{ServingBS→Neighborin gBS}=f(σ_{ServingBS}², σ_{Neighborin gBS}²μ, NI_{Neighborin gBS})
where f( ) denotes a specific function, II_{ServingBS→NeighboringBs} denotes a hysteresis margin value used for determining handover from the serving BS to the neighboring BS, σ_{ServingBS}² and σ_{NeighboringBS}² respectively denote variances of strengths of the signals received from the serving BS and the neighboring BS, μ denotes frequency of unnecessary handovers, broadcast from the serving BS, and NI_{NeighboringBS} denotes an interference level value of the neighboring BS.

19. The wireless mobile communication system of claim 14, wherein the handover request message comprises the identifier of the neighboring BS.
